(19) United States
(12) Patent Application Publication
(10) Pub. No.: US 2026/0134377 A1
(43) Pub. Date: May 14, 2026

(54) ORGANIZATION OF WORKSPACES

(71) Applicant: Notion Labs, Inc., San Francisco, CA (US)

(72) Inventors: Marissa Jessica Lafontant Felix, Brooklyn, NY (US); Gabriel Borges, San Francisco, CA (US); Birkan Icacan, San Francisco, CA (US)

(21) Appl. No.: 18/942,223

(22) Filed: Nov. 8, 2024

(51) Int. Cl. G06Q 10/067; G06Q 10/0631

(52) U.S. Cl. CPC G06Q 10/067; G06Q 10/06315

(57) ABSTRACT

Methods and devices for applying configurations across all the workspaces that belong to an organization without structurally consolidating the workspaces are disclosed. In one example aspect, an enterprise system includes a first workspace created by a first set of users, a second workspace created a second set of users, and an organization-level space associated with the first workspace and the second workspace. A setting configured in the organization-level space is applied to the first workspace and the second workspace without impacting independent operations of the first workspace and the second workspace.

### BACKGROUND

Workspaces (e.g., digital workspaces) refer to environments that assemble tools and platforms that allow users to work, communicate, and produce work products together. Workspaces can be desktop or web-based applications that allow multiple users to share and access the workspaces in a variety of manners. At the same time, a user can be part of multiple workspaces to contribute and manage different aspects of work products or an organization.

### BRIEF DESCRIPTION OF THE DRAWINGS

Reference will now be made, by way of example, to the accompanying drawings, which show example embodiments of the present application and in which:

FIG. 1 is a block diagram of an example platform that leverages a block data model in accordance with one or more embodiments of the present technology.

FIG. 2A illustrates an example user interface showing multiple workspaces associated with a user in accordance with one or more embodiments of the present technology.

FIG. 2B illustrates an example user interface associated with one or more teamspaces of a user in accordance with one or more embodiments of the present technology.

FIG. 3 is a block diagram illustrating a hierarchical organization of pages in a workspace in accordance with one or more embodiments of the present technology.

FIG. 4A illustrates an example of three workspaces created by users in different stages of an organization in accordance with one or more embodiments of the present technology.

FIG. 4B illustrates an example of a logical organization-level container based on the block data model to manage configurations across different workspaces in accordance with one or more embodiments of the present technology.

FIG. 5A illustrates an example of four workspaces created by users of an organization in accordance with one or more embodiments of the present technology.

FIG. 5B illustrates an example of growing workspaces created by users of an organization in accordance with one or more embodiments of the present technology.

FIG. 5C illustrates an example of separate organizations in accordance with one or more embodiments of the present technology.

FIG. 6 illustrates an example enterprise system having one or more organization-level spaces in accordance with one or more embodiments of the present technology.

FIG. 7 is a flowchart representation of a computer-implemented method for managing enterprise-level information in accordance with one or more embodiments of the present technology.

FIG. 8A illustrates an example interface for an organization administrator in accordance with one or more embodiments of the present technology.

FIG. 8B illustrates another example interface for an organization administrator in accordance with one or more embodiments of the present technology.

FIG. 8C illustrates yet another example interface for an organization administrator in accordance with one or more embodiments of the present technology.

FIG. 9 illustrates an example setting interface for an organization administrator to manage users across multiple workspaces in accordance with one or more embodiments of the present technology.

FIG. 10A illustrates an example setting interface for an organization administrator to manage multiple workspaces in accordance with one or more embodiments of the present technology.

FIG. 10B illustrates an indicator of setting conflicts for an organization administrator to manage multiple workspaces in accordance with one or more embodiments of the present technology.

FIG. 10C illustrates an example user interface for applying configuration to specific workspaces in accordance with one or more embodiments of the present technology.

FIG. 11 illustrates an example setting interface for an organization administrator to manage organization identifier information across multiple workspaces in accordance with one or more embodiments of the present technology.

FIG. 12A is a flowchart representation of a computer-implemented method for managing enterprise-level information for an organization in accordance with one or more embodiments of the present technology.

FIG. 12B is a flowchart representation of another computer-implemented method for managing enterprise-level information for an organization in accordance with one or more embodiments of the present technology.

FIG. 12C is a flowchart representation of yet another computer-implemented method for managing enterprise-level information for an organization in accordance with one or more embodiments of the present technology.

FIG. 13 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Section headings are used in the present document only to improve readability and do not limit the scope of the disclosed embodiments and techniques in each section to only that section.

Workspaces are applications that allow multiple users to share and access the workspaces in a variety of manners. A user can be a member of multiple workspaces. The user can also join another existing workspace or create a new workspace. With the growth of an organization and its users, more workspaces can be created, posing challenges to an administrator, who may have to manually configure over ten, twenty, or more workspaces individually and repetitively.

The present technology provides techniques that can be implemented in various embodiments to enable a uniform and efficient approach to apply configurations (e.g., organization-level or enterprise-level settings) across workspaces that belong to an organization without structurally consolidating the workspaces, thereby maintaining the separation of workspaces for their functional or geographical attributes, as well as minimizing impact to end users of the workspaces.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc. are all blocks in a workspace. The attributes of a block determine how that information is rendered and organized. Every block can have attributes, including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, like blocks, users, workspaces, etc. Because many actions usually change more than one record, operations are batched into transactions that are committed (or rejected) by the server as a group.

Creating and updating blocks can be performed by, for example, pressing enter on a keyboard. First, the client defines all the initial attributes of the block, generating a new unique ID, setting the appropriate block type (to_do), and filling in the block's properties (an empty title and checked: [“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory, and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to share with others. Usually, TransactionQueue sits empty, so the transaction to create the block is sent to the server in an API request. In one example, the transaction data is serialized to JSON and posted to the/saveTransactions API endpoint. SaveTransactions gets the data into source-of-truth databases, which store all block data, as well as other kinds of persisted records. Once the request reaches the API server, all the blocks and parents involved in the transaction are loaded. This gives a “before” picture in memory. The block model duplicates the “before” data that had just been loaded in memory. Then, the block model applies the operations in the transaction to the new copy to create the “after” data. Then, the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to MessageStore, which is a real-time updates service. When the client renders a block (or page or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of newly recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, it sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

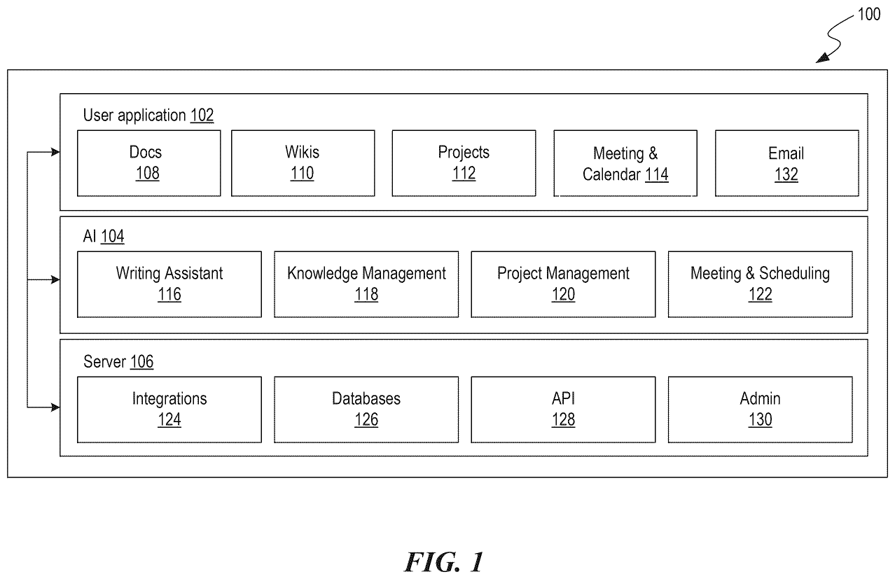

FIG. 1 is a block diagram of an example platform 100 that leverages the block data model. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The AI tool 104 is an integrated AI assistant that enables AI-based functions for the user application 102. In one example, the AI tool 104 is based on a neural network architecture. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Workspaces and Teamspace

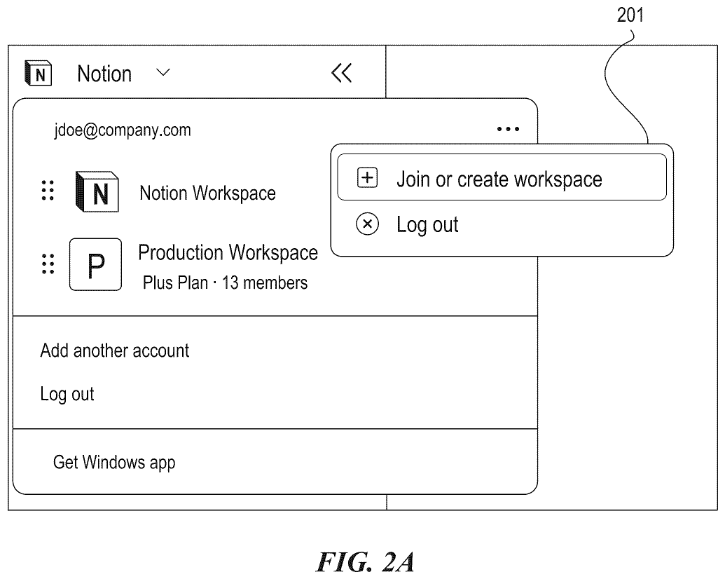

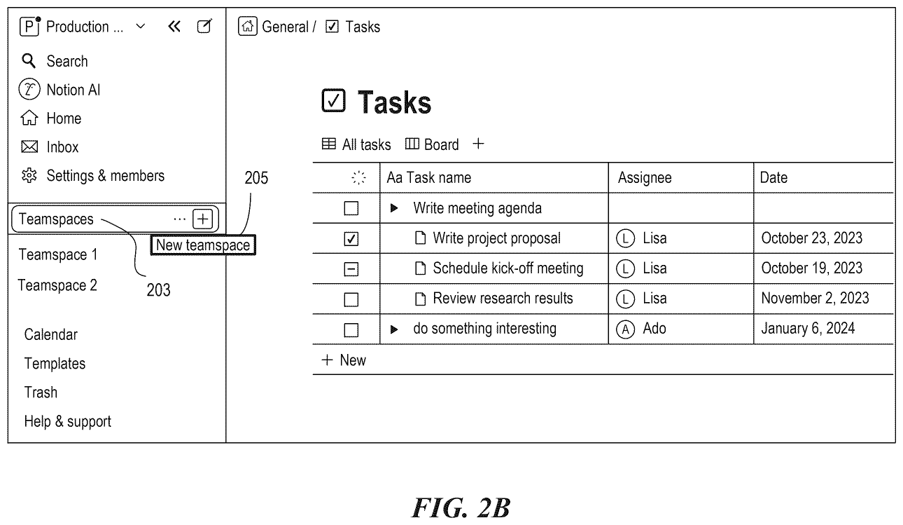

Workspaces are desktop or web-based applications that allow multiple users to share and access the workspaces in a variety of manners. A user can be a member of multiple workspaces. FIG. 2A illustrates an example user interface showing multiple workspaces (e.g., Notion workspace, Production Workspace) associated with a user in accordance with one or more embodiments of the present technology. The user can also join another existing workspace or create a new workspace via the user interface control 201.

A teamspace refers to a collaborative space associated with a team or an organization that is hierarchically below a workspace. FIG. 2B illustrates an example user interface associated with one or more teamspaces of a user in accordance with one or more embodiments of the present technology. As shown in FIG. 2B, one or more teamspaces 203 can exist below a workspace, each associated with a list of tasks and/or other team information. A user can also add a new teamspace via the user interface control 205.

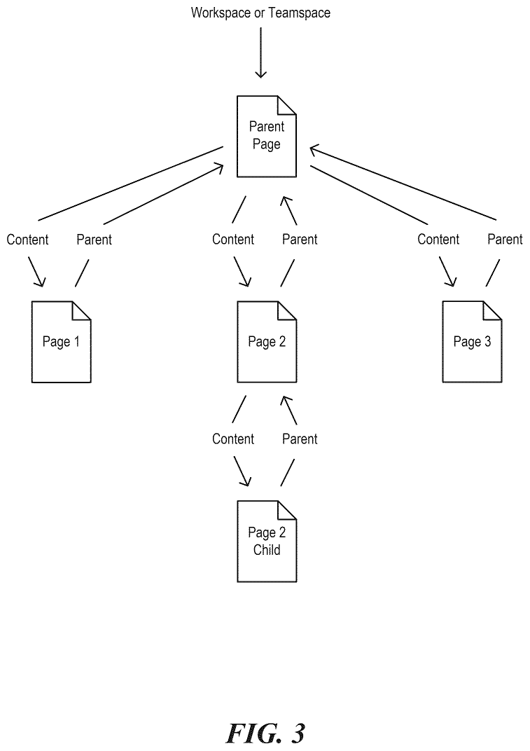

Workspaces and teamspaces can be organized hierarchically. FIG. 3 is a block diagram illustrating a hierarchical organization of pages in a workspace in accordance with one or more embodiments of the present technology. As described with respect to the block data model of the present technology, a workspace can include multiple pages (e.g., page blocks). The pages (e.g., including parent pages and child or nested pages) can be arranged hierarchically within the workspace or one or more teamspaces. The page can include a block such as tabs, lists, images, tables, etc. For example, a workspace can include a teamspace accessible by all users of a division and multiple teamspaces that are accessible by users of different teams in the division. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

In an organization or an enterprise, different divisions are typically structured to handle specific functions and responsibilities. Each division has its own unique focus, goals, and operational methods. Referring back to FIG. 2A above, workspaces dedicated to different functions and responsibilities can be created by individual users, e.g., in a bottom-up manner, to take actions for a project and/or to organize information in a division. Accordingly, workspaces are often context related, created for specific projects or functions (e.g., engineering, legal, finance). From an organization or an enterprise point of view, it is desirable to keep at least some of the workspaces separate as they correspond to different functionalities of the organization. For example, how a finance division manages its information can be vastly different from how an engineering division manages its information. Workspaces can also have differences caused by geographical locations. For example, an engineering division in Japan may be structured differently as compared to an engineering division in Australia. The two divisions need to comply with different regulations and laws in different jurisdictions. Yet, certain configurations, such as Information Technology (IT) settings, security controls, and/or other types of settings common to various types of divisions and teams need to be applied to workspaces under the same organization.

As more workspaces are created in the bottom-up matter with the growth of an enterprise, an administrator may have to configure many workspaces individually, which is challenging due to at least the following reasons:

Complexity and Diversity of Workspaces: As mentioned above, different workspaces have varying functionalities, dependencies, and configurations. Ensuring that a uniform setting applies appropriately to each workspace can be complex.

Consistency and Compatibility. Ensuring consistent enterprise settings across all workspaces can be difficult when the workspaces adapt to the needs of different teams over time. Referring back to FIG. 3, users may modify access information individually in the hierarchical structure of workspace/teamspaces. Compatibility issues may arise if a setting that works for one workspace/teamspace causes issues in another.

Configuration Management: When configuring the workspaces individually, keeping track of which settings have been applied to which workspace can be cumbersome.

Testing and Validation: Thorough testing is required to ensure that the settings do not break functionality or introduce vulnerabilities to workspaces. Validation across multiple workspaces is necessary to ensure consistency but requires the workspaces to be disabled temporarily, which impacts normal usage of the workspaces by users.

Compliance and Policy Enforcement: Ensuring that all workspaces comply with organizational policies and regulatory requirements can be challenging. Continuous monitoring and enforcement mechanisms need to be in place to ensure compliance.

This patent document disclosed techniques that can be implemented in various embodiments to enable an organization administrator to apply configurations (e.g., organization-level or enterprise-level settings) uniformly and efficiently across workspaces that belong to the organization. No structurally change to the workspaces is needed. There is also no need to temporarily disable workspaces to apply the configurations. Using the disclosed techniques, independent operations of the workspaces can be maintained, with minimal interruption to users' day-to-day activities in workspaces.

### Organization Administration Blocks

Currently, an administrator needs to become a member of all workspaces and log into each workspace to view and manage administrative information. There exists a need for administrators to manage common administrative information across multiple workspaces and workspace-level or teamspace-level settings if they are overridden by users at the workspace(s) and teamspace(s).

In some embodiments, an organization administrative block can be implemented based on the foundation of the block data model discussed above. Blocks are content containers that function as data sources for storing various types of information. The data sources formed by the blocks are fundamentally different from the conventional relational databases in which a standard programming language, such as Structured Query Language (SQL), is needed to store and process information.

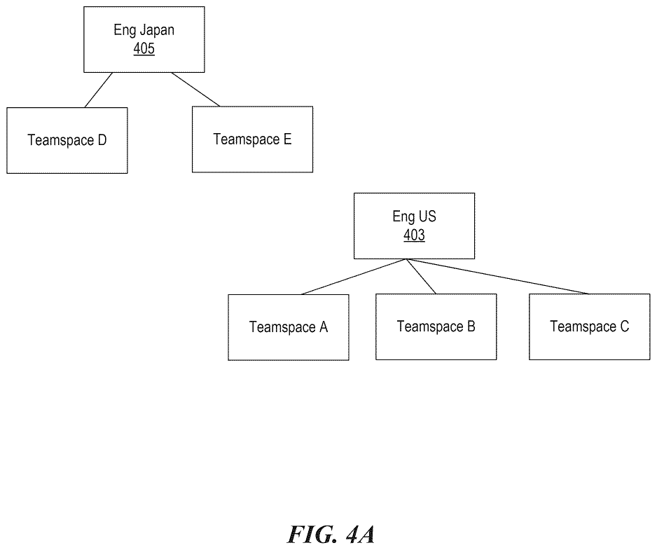

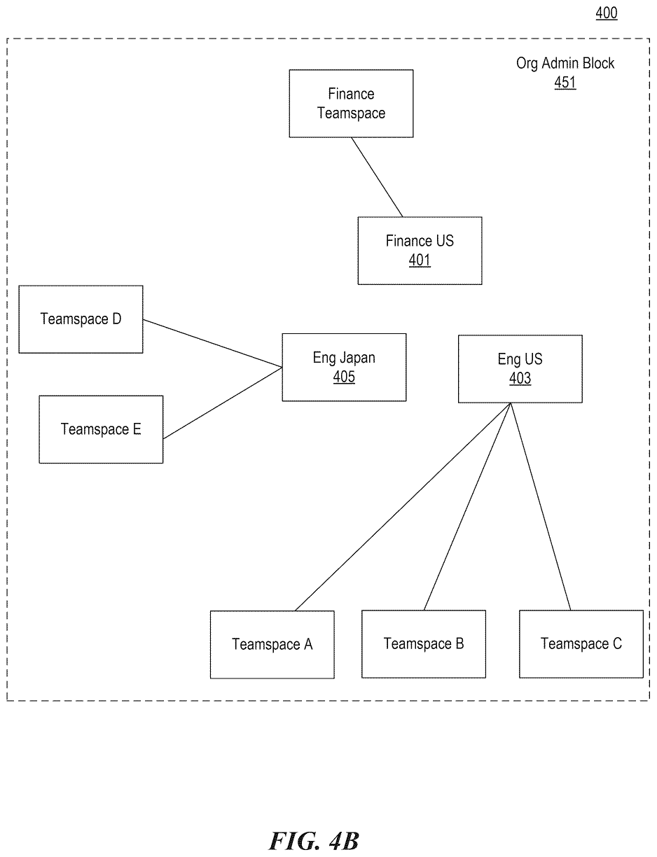

FIG. 4A illustrates an example of three workspaces created by users in different stages of an organization 400 in accordance with one or more embodiments of the present technology. In this example, three workspaces have been created over time by different individual users based on the geo-location and/or functionalities of the divisions that the users are associated with. The organization started with its U.S. teams initially, with teams in different functional areas. For example, the finance division creates a “Finance US” workspace 401 to focus on budgeting, forecasting, financial analysis, and compliance with financial regulations, while the engineering division created an “Eng US” workspace 403 to ensure efficient software development processes and timely product releases. The organization 400 grew and expanded overseas, establishing similar functional divisions internationally (e.g., engineering division in Japan, with workspace “Eng Japan” 405). Such oversea divisions need to follow regulations in respective jurisdictions, leading to somewhat different structures as compared to their U.S. domestic counterparts. Therefore, structural consolidation of these workspaces may not be desirable. However, the organization still needs to apply certain organization-level or enterprise-level settings to its workspaces.

FIG. 4B illustrates an example of an organization-level container based on the block data model to manage configurations across different workspaces in accordance with one or more embodiments of the present technology. In this example, to effectively manage the IT/security aspects of the existing workspaces, an organization administration block 451 can be added to logically group the top-level containers of the workspaces (401, 403, 405) together. Table 1 shows an example implementation of the organization administration block. An organization entity can have a name and an identifier. As the organization evolves, the entity can also be associated with a version that is indicative of its change history.

TABLE 1
An example implementation of the
organization administration block

Interface OrganizationEntity {
id: string
name: string
version: number
// additional attributes }

In some embodiments, the organization administration block is not considered as a parent block of the top-level workspace containers. This is because the workspaces are expected to remain independent from each other, and adopting a structural change between the organization administration block and the workspace containers can eliminate the independence among the workspaces. In some cases, one workspace can also belong to multiple organizations. For example, a research and development division can belong to both the parent organization and a subsidiary organization, based on inter-company agreement(s) or during the early stage of the subsidiary. Representing such a relationship using two parent blocks can be problematic.

In some embodiments, the relationship between the organization administration blocks and the workspaces can be implemented as a joined table that provides multiple-to-multiple mapping of the organization block(s) to the workspace(s). Table 2 shows an example implementation of the relationship between organization administration block(s) and workspace(s).

TABLE 2
An example relationship between organization
block(s) and workspace(s)

Interface OrganizationSpace {
Organization_id: Record<OrganizationTable>
Space_id: Record<SpaceTable>
// additional attributes
}

The joined-table approach allows the existing workspaces to function independently (e.g., each top-level workspace block is considered as the root of the workspace) and to be flexibly grouped together to enable application of the enterprise-level settings.

A new role, called organization administrator, can be added to enable selected users (e.g., administrators) to manage the workspaces. The organization administration block 451 is visible to the administrator(s) but not visible to any non-administrator users. Settings applied in the organization administration block 451 can be propagated to different workspaces corresponding to the hierarchical structure as shown in FIG. 3. For example, settings can be inherited by the child nodes (e.g., workspaces and/or teamspaces) along the hierarchical structure.

To be able to organize existing workspaces that were created prior to the organization-level container, an attribute that distinguishes one organization from another can be used to filter and group the existing workspaces. For example, a company name or a company logo can be used to distinguish a company from another. Sometimes, however, as the organization grows, the organization can spin off different subsidiaries to create new, independent companies. Part of the parent company's operations, assets, and liabilities is separated to the subsidiaries. In some cases, the subsidiaries are still considered as part of the organization. In some cases, however, it is more desirable to treat the subsidiaries as separate organizations. Accordingly, an attribute (e.g., an organization identifier) that can uniquely and flexibly identify an organizational entity is needed.

In some embodiments, the organization identifier can at least partly be represented using one or more domain names. Table 3 shows an example implementation of an organization identifier represented using one or more domain names.

TABLE 3
An example implementation of an organization identifier

{
Id: “organization-id”,
domains {“abc.com”, “xyz.com”} ... }

In some embodiments, a workspace can start without a domain name. However, the creator of the workspace (or the workspace owner) is associated with an email address. The email address of the workspace owner can be used as the domain name and an identifier for the workspace to determine whether the workspace can be associated with a particular organization.

In some embodiments, an organization can start with a single domain name and expand to additional domain names overtime. Allowing the organization identifier to be represented using one or more domain names provides the flexibility to update the organization administration block when the organization structure changes. Because the organization administration block is a logical container organizing the workspaces, updating the organization structure can simply involve re-filtering the existing workspaces using the organization identifier without introducing any changes to the workspaces themselves.

In some embodiments, some workspaces are subject to the same Security Assertion Markup Language (SAML) configuration(s). Having the same SAML configurations indicate that the workspaces share at least part of the security settings and should be considered as belonging to the same organization. Therefore, the organization identifier can also include the SAML configuration(s). Table 4 shows an example implementation of an organization identifier represented using SAML configuration.

TABLE 4
Another example implementation of an organization identifier

{
Id: “organization-id”,
saml_configs {config1, config2}
... }

A SAML configuration can also include an attribute indicating domain name(s). Accordingly, in some embodiments, the domain name(s) and the SAML configuration(s) can be combined as an identifier to identify existing workspaces that belong to the same organization. Table 5 shows an example implementation of an organization identifier represented using the domain names included in SAML configuration.

TABLE 5
Yet another example implementation of an organization identifier

{
Id: “organization-id”,
saml_configs {
config.email_domains {“abc.com”, “xyz.com”} ... }

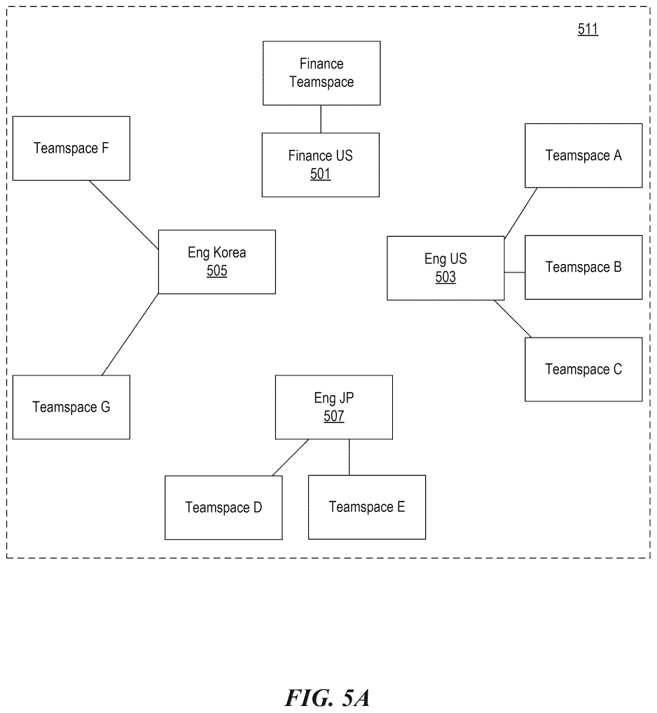

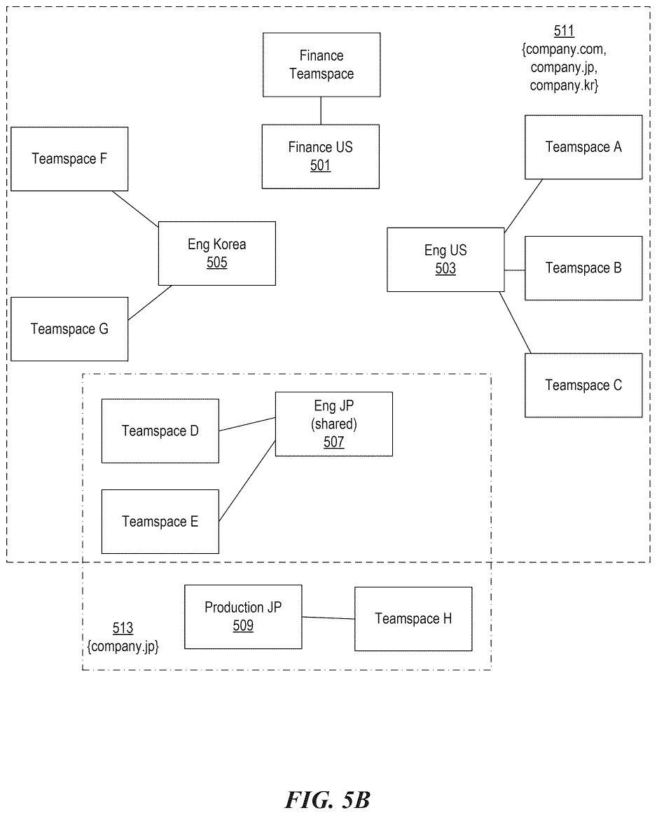

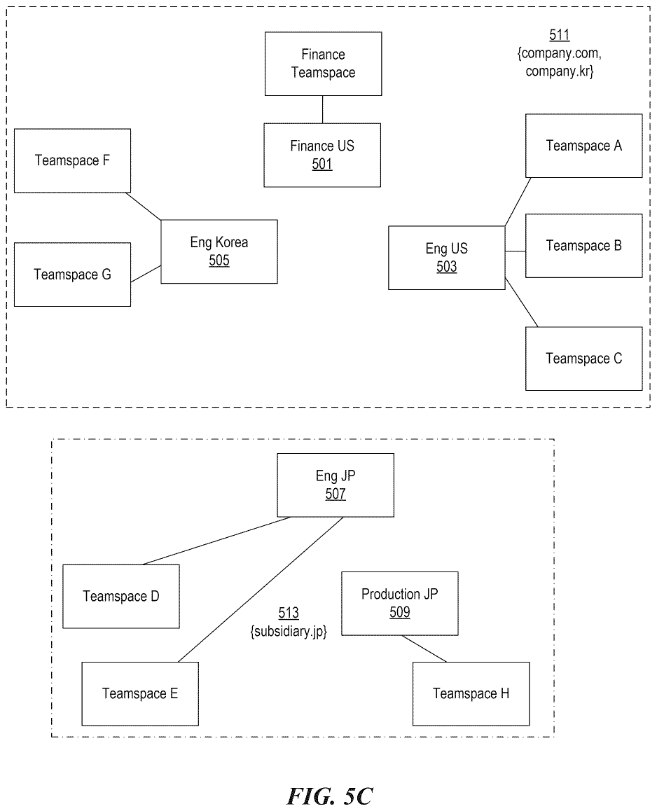

FIG. 5A illustrates an example of four workspaces created by users of an organization in accordance with one or more embodiments of the present technology. In this example, the organization has grown to have different domestic and international divisions: finance U.S. 501, engineering U.S. 503, engineering Korea 505, and engineering Japan 507. Given the growing number of workspaces, an organization administration block 511 was created, based on an organization identifier, to associate these workspaces together so that settings can be applied/propagated to all four workspaces. In this example, the organization identifier includes multiple domain names, such as “company.com,” “company.jp,” and “company.kr.”

FIG. 5B illustrates an example of growing workspaces created by users of an organization in accordance with one or more embodiments of the present technology. Another workspace, production Japan workspace 509, was created to manage information related to the manufacturing and production of the products. More workspaces were expected to be created to manage business operations in Japan, and it is expected that operations in Japan would eventually be separated from the existing organization to form a subsidiary. To adapt to the business strategy changes, a second organization administration block 513 was created to associate the engineering Japan workspace 507 and the production Japan 509. It is noted that the engineering Japan workspace 507 is considered as shared at this point. The engineering Japan workspace 507 can be associated with the organization administration block 511 and accessible in the second organization administration block 513. Alternatively, the engineering Japan workspace 507 can be associated with the second organization administration block 513 and accessible in the organization administration block 511.

Over time, operations in Japan continued to grow. A separate subsidiary was established in Japan, with its own separate domain name. Accordingly, the two organizations can be updated to reflect the changes in the evolving organizational structure. FIG. 5C illustrates an example of separate organizations in accordance with one or more embodiments of the present technology. The organization administration block 511 can be updated to reflect that the organization identifier includes “company.com” and “company.kr” only. The association between the organization administration block 511 and the workspaces can be refreshed based on the updated organization identifier. Similarly, the organization administration block 513 can be updated to reflect that the organization identifier includes “subsidiary.jp.” The association between the organization administration block 513 and the workspaces can also be updated. Alternatively, or in addition, business rules (e.g., organizational legal structures, workspace functional attributes) can be used as the criteria for determining the grouping/association of workspace(s) with the organization administration block(s). It is noted that the engineering Japan workspace 507 now is associated with only the organization administration block 513.

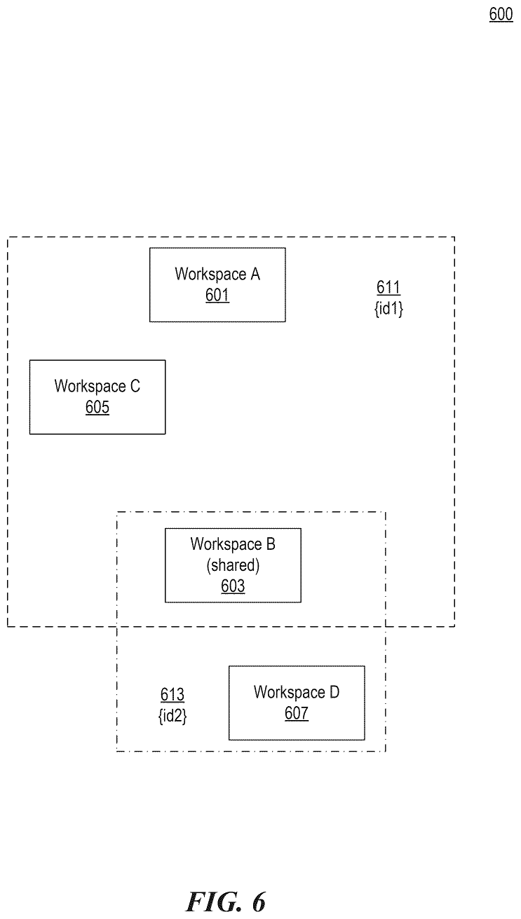

In some embodiments, the implementation of the organization-level space(s), workspace(s), and/or teamspace(s) does not depend on the block data model. FIG. 6 illustrates an example enterprise system having one or more organization-level spaces in accordance with one or more embodiments of the present technology. The enterprise system 600 includes a first workspace 601 (e.g., Workspace A). The first workspace includes information or content created by a first set of users (e.g., the research and development team). The information or content can be organized in a non-block manner (e.g., in a traditional database, in a tabular format, and/or as unstructured documents). The enterprise system 600 includes a second workspace 603 (e.g., Workspace B). The second workspace includes information or content created by a second set of users (e.g., the manufacturing team). The information or content can also be organized in a non-block manner (e.g., in a traditional database, in a tabular format, and/or as unstructured documents). In some cases, the first set of users and the second users are two completely different sets of users (e.g., no overlap of personnel between the finance team and the research and development team). In some cases, some users may belong to both the first set and the second set (e.g., users that are both part of the research and development team and the manufacturing team). The enterprise system can also include additional workspaces (e.g., Workspace C 605, Workspace D 607). The operations of the workspaces can involve collaboration between the teams but remain largely independent from each other.

The enterprise system also includes at least one organization-level space (e.g., space 611, space 613). An organization-level space (e.g., space 611) is associated with the first workspace (e.g., Workspace A) and the second workspace (e.g., Workspace B). An organization identifier (e.g., id1) can be used to determine which workspaces are associated with the organization. For example, Workspace A and Workspace B share a common attribute (e.g., a domain name or a SAML configuration). The common attribute can be used to group/associate the organization-level space with the workspace(s). After the association is established, a setting configured in the organization-level space is applied and/or propagated to the first workspace and the second work without impacting independent operations of the first workspace and the second workspace. There is also no need to temporarily disable any of the workspaces, thereby minimizing impact on workspace users. Additional organization-level space(s) (e.g., space 613) can be created to associate with other workspaces (e.g., Workspace A, Workspace C). In some embodiments, shared workspaces can be created. A shared workspace (e.g., Workspace B) can be part of one organization-level space and be accessible in other organization-level spaces (e.g., Workspace B is under organizational level space 611 and is also accessible within organizational level space 613).

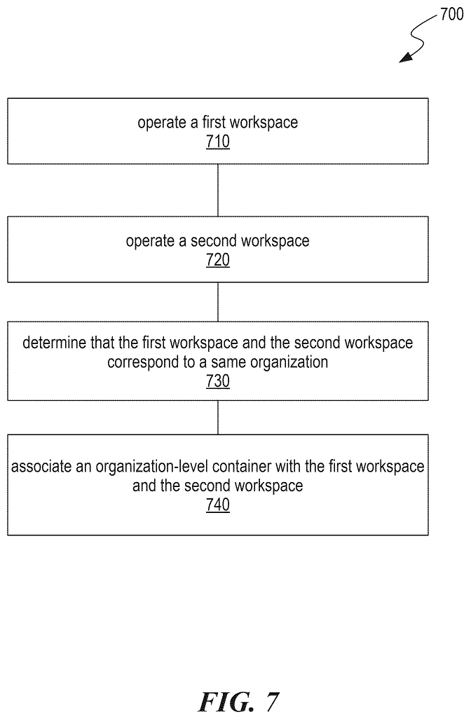

FIG. 7 is a flowchart representation of a computer-implemented method for managing enterprise-level information in accordance with one or more embodiments of the present technology. The method 700 includes, at operation 710, operating a first workspace associated with a first hierarchy of first multiple records arranged in multiple levels. A record among the first multiple records includes content created by a first set of users. The method 700 includes, at operation 720, operating a second workspace associated with a second hierarchy of second multiple records arranged in multiple levels independently from the first workspace. A record among the second multiple records includes content created by a second set of users. The second set of users is at least partially different from the first set of users (e.g., users belong to different business functions and/or geographical locations). The method 700 includes, at operation 730, determining, based on an attribute that is common to the first workspace and the second workspace, that the first workspace and the second workspace correspond to a same organization. The method 700 includes, at operation 740, associating an organization-level container with the first workspace and the second workspace based on the attribute such that a setting configured in the organization-level container (e.g., by an organization administrator) is applied to the first workspace and the second workspace without impacting independent operations of the first workspace and the second workspace.

In some embodiments, the method includes, after associating the organization-level container with the first workspace and the second workspace, operating the second workspace independently from the first workspace. In some embodiments, the attribute comprises at least one of a domain name of the organization or a security configuration of the organization.

In some embodiments, associating the organization-level container with the first workspace and the second workspace comprises using a joined table approach such that there exists and correspondence between a first table comprising the organization-level container and a second table comprising the first workspace and the second workspace.

In some embodiments, the method includes applying the setting configured in the organization-level container to all workspaces associated with the organization-level container such that the setting configured in the organization-level container is modifiable only by an organization administrator of the organization.

In some embodiments, the method includes applying the setting configured in the organization-level container to a subset of workspaces associated with the organization-level container such that the setting configured in the organization-level container is modifiable by a workspace owner of one of the subset of the workspaces.

In some embodiments, the setting configured in the organization-level container is applied to the first workspace and the second workspace according to a rule that is based on at least one of (1) a user type, or (2) a status of the first workspace or the second workspace.

### Organization Administrator

As mentioned above, to be able to centrally manage settings of multiple workspaces, a new role called organization administrator is added to manage organization-level configurations. Table 6 shows an example implementation of the organization administrator role.

TABLE 6
An example implementation of the organization administrator role

Interface OrganizationSpace {
...
Roles: Array<{
user id: Record<UserTable>
role: “admin”}> ... }

A joined-table approach can also be used to manage the relationship between the users and the organizations. Table 7 shows an example implementation of the relationship between organization administration block(s) and administrator(s). This way, each organization administration block can have multiple administrators, and each user can be an administrator for multiple organization administration blocks. In some cases, an organization administrator can manage multiple workspaces associated with an organization without being a member of one or more of the workspaces. For example, an IT administrator is not a part of the finance division workspace and cannot access the finance data included in the workspace. The IT administrator, however, can apply organization-level security settings to the finance division workspace to ensure consistency across different workspaces in the organization.

TABLE 7
An example relationship between organization
block(s) and administrator (s)

Interface OrganizationSpace {
Organization_id: Record<OrganizationTable>
User_id: Record<UserTable>
Role: “admin” ... }

In some embodiments, a tool can be provided to the organization administrators to configure different settings for the organization(s). In some implementations, the tool can be implemented as a portal/user interface that is integrated with the existing workspace system. The tool is visible to organization administrators, while regular workspace members continue to interact with their work content at the workspace level and are not impacted by changes made via the organization-level tool.

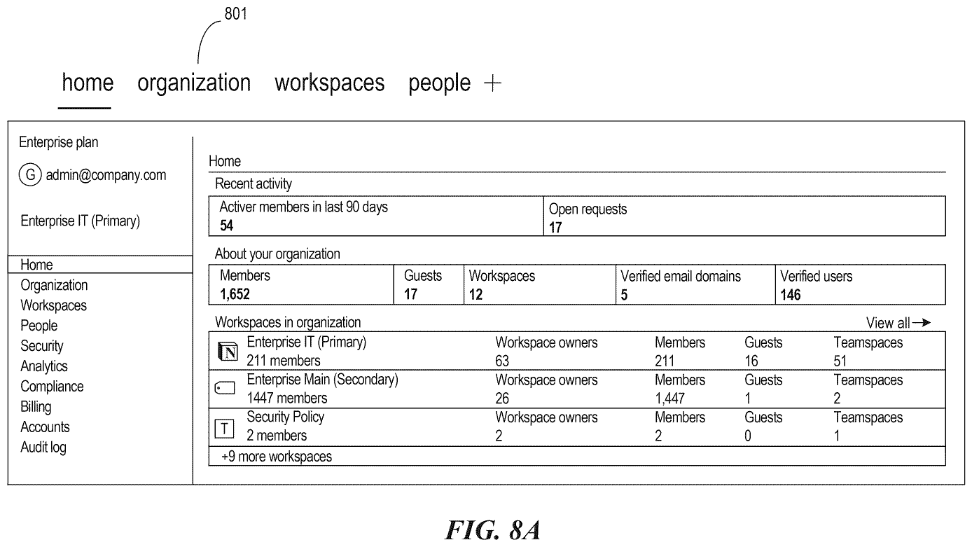

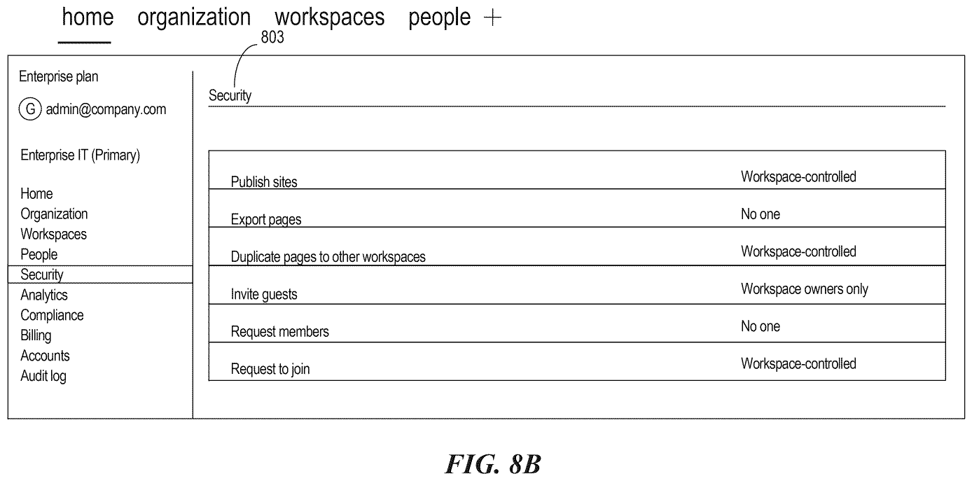

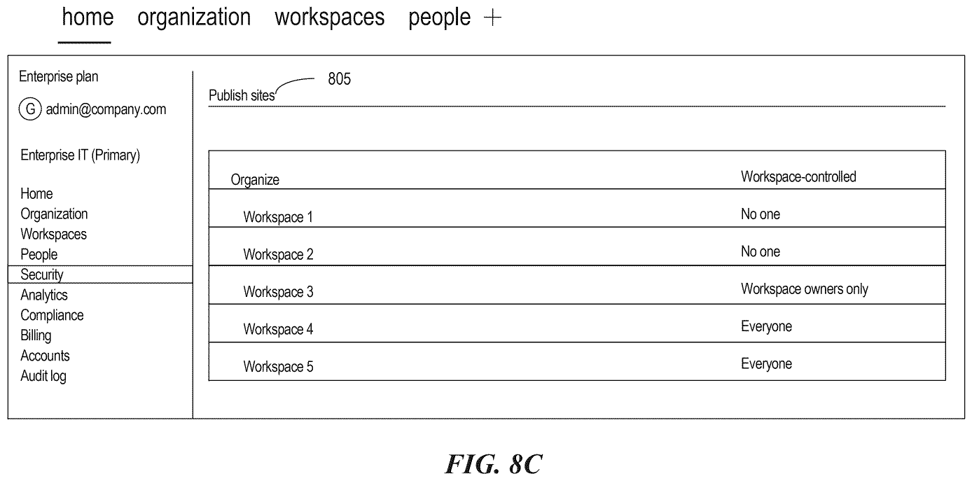

FIG. 8A illustrates an example interface for an organization administrator in accordance with one or more embodiments of the present technology. As shown in FIG. 8A, a separate, dedicated tab 801 showing organization-level information is visible to the organization administrator. Upon clicking on the tab 801, a summary of information related to the members and workspaces that are associated with the organization is provided to the organization administrator.

FIG. 8B illustrates another example interface for an organization administrator in accordance with one or more embodiments of the present technology. In this example, access permission is used as an example for security settings 803. The organization administrator can quickly determine the access permissions for different operations at a high level. For example, at the organization level, exporting pages and requesting members are disabled for all workspace members and invite guests is only allowed for workspace owners. The access permissions for other operations are controlled at the workspace level.

The interface can also provide a uniform portal for the organization administrator to organize settings for multiple workspaces at the same place. FIG. 8C illustrates another example interface for an organization administrator in accordance with one or more embodiments of the present technology. In this example, the organization administrator wants to configure specific access permissions for “publish sites” 805 for different workspaces. The organization can be expanded into a list of workspaces (e.g., Workspace 1, Workspace 2, etc.), with corresponding workspace-level configurations. Each workspace can be further expanded into teamspaces so that the organization administrator can configure the settings at the teamspace level. The organization administrator can easily apply the settings at different levels without the need for logging into individual workspaces and repeatedly applying the setting(s) to each workspace.

It is noted that the organization administrator can perform similar controls not just to security settings, but also to organization-level configurations in other areas, such as compliance, organization analytics, and/or billing, without the need to be granted access to content in the individual workspaces.

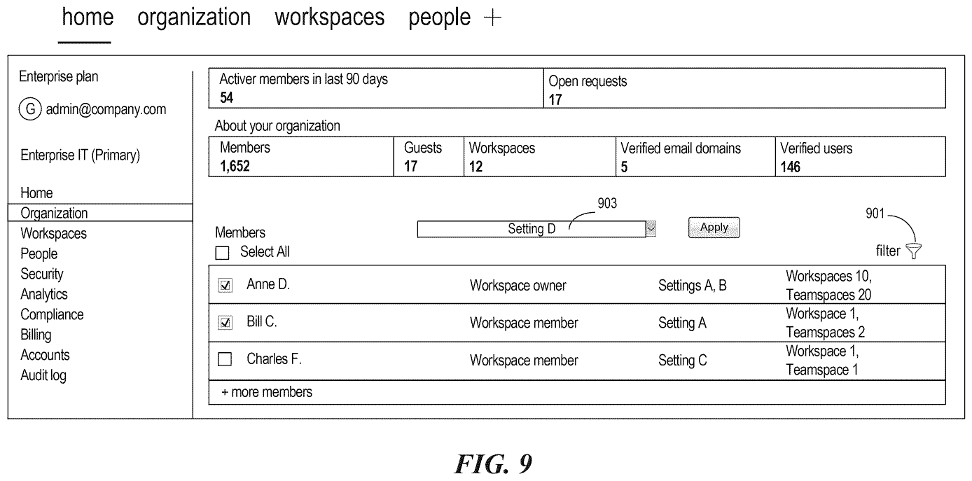

FIG. 9 illustrates an example interface for an organization administrator to manage users across multiple workspaces in accordance with one or more embodiments of the present technology. Because a user can be members to different workspaces, once the workspaces are associated with the organization, simply pulling user information from the workspaces results in a lot of duplicated user information. The interface can provide a list of de-duplicated members that belong to the same organization. This list can enable the organization administrator to have an accurate count of the number of users in the organization. Such information can be helpful for certain organization management tasks, e.g., for service cost estimates determined based on the number of users.

The setting interface can also enable the organization administrator to bulk-manage members in an organization. As shown in FIG. 9, a particular setting (e.g., IT/security setting) can be selected from the dropdown box 903 or other user interface component(s). In this specific example, given that the organization has a total of 1,652 members, individual configuration of each member is not a feasible task for the organization administrator. The organization administrator can select certain members using filtering criteria 901 (e.g., the user type, the associated workspaces/teamspaces). The setting (e.g., Setting D) can be applied in bulk to the selected users (e.g., Select All members based on the filtering criteria, or select a subset of the members). In some embodiments, the list of settings can be obtained from the security settings (e.g., discussed in connection with FIGS. 8B-C), compliance settings, analytics settings, and/or billing settings that are configured by the organization administrator in other pages of the interface. In some embodiments, setting(s) made to selected members at the organization level can be saved as a template for the future. For example, a particular set of security configurations is applicable to workspace owners. The action of applying this set of security configurations can be saved as a template and be repeated, periodically or aperiodically, for future user management.

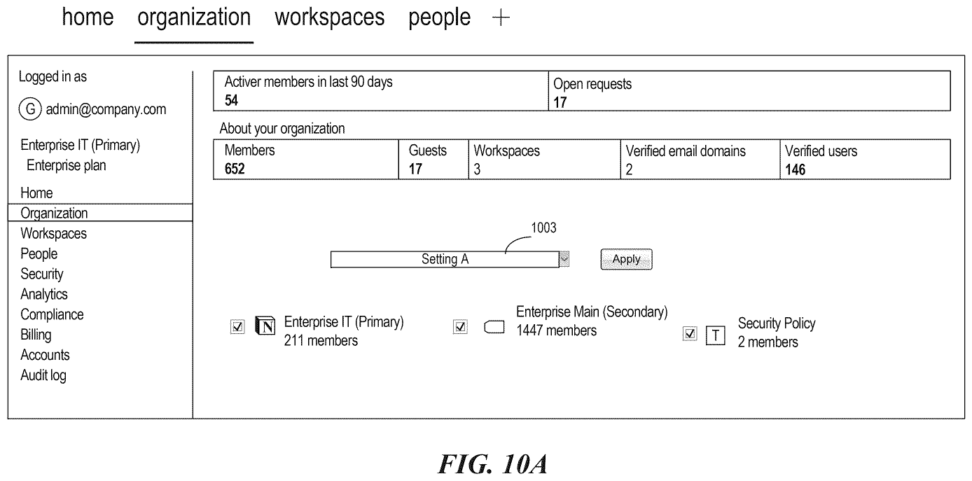

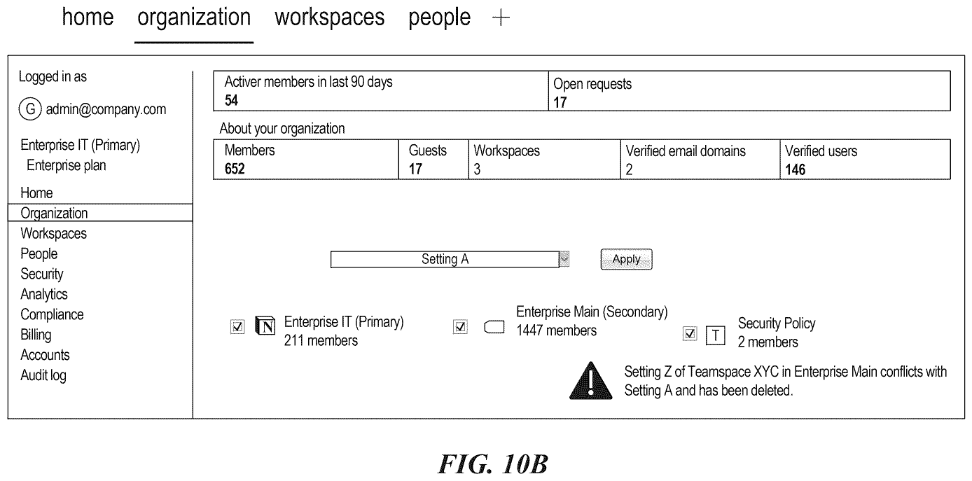

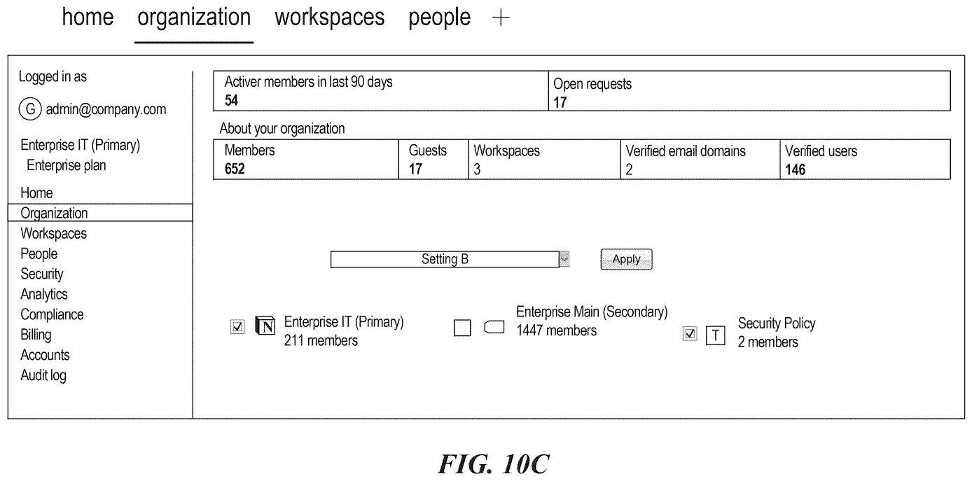

FIG. 10A illustrates an example setting interface for an organization administrator to manage multiple workspaces in accordance with one or more embodiments of the present technology. The setting interface can enable the organization administrator to bulk-manage workspaces in an organization. As shown in FIG. 10A, a particular setting (e.g., IT/security setting) can be selected from the dropdown box 1003 or other user interface component(s). In some embodiments, in the default mode, the selected setting is applied to all workspaces that the organization administrator has the authority to manage (e.g., all workspaces are checked). For example, an important security setting that is applicable to all workspaces of the organization can be applied this way. After the organization administrator clicks the “Apply” button, Setting A is automatically applied and propagated to all workspaces and teamspaces in the hierarchical structure. In some embodiments, if a setting is applied globally to all workspaces associated with the organization, the setting can be considered as a mandatory setting that all workspaces comply with. Once the organization administrator sets the setting at the top level, workspace owners and/or teamspace owners cannot modify it. In some embodiments, the list of settings can be obtained from the security settings (e.g., discussed in connection with FIGS. 8B-C), compliance settings, analytics settings, and/or billing settings that are configured by the organization administrator in other pages of the interface.

In some embodiments, one or more of the workspaces or teamspaces in the hierarchical structure can have one or more existing settings that conflict with the global setting. FIG. 10B illustrates an indicator of setting conflicts for an organization administrator to manage multiple workspaces in accordance with one or more embodiments of the present technology. As shown in FIG. 10B, after applying Setting A to all workspaces, a warning message is displayed to indicate that Setting Z in a teamspace of the Enterprise Main workspace conflicts with Setting A. In some implementations, the conflicting setting at a lower workspace/teamspace in the hierarchical structure can be automatically deleted. In some implementations, the organization administrator can determine to manually resolve such conflicts. For example, an interface can be provided to the organization administrator so that the organization administrator can determine which setting(s) should be removed/revised.

In some embodiments, the organization administrator can apply a specific workspace setting without propagating to other workspaces. FIG. 10C illustrates an example user interface for applying configuration to specific workspaces in accordance with one or more embodiments of the present technology. In this example, the organization administrator selects two workspaces—Enterprise IT and Security Policy—to apply Setting B. In some embodiments, if a setting is not applied globally to all workspaces associated with the organization, but only to a selected subset for easier bulk management, the setting can be considered as a setting modifiable by workspace owners and/or teamspace owners.

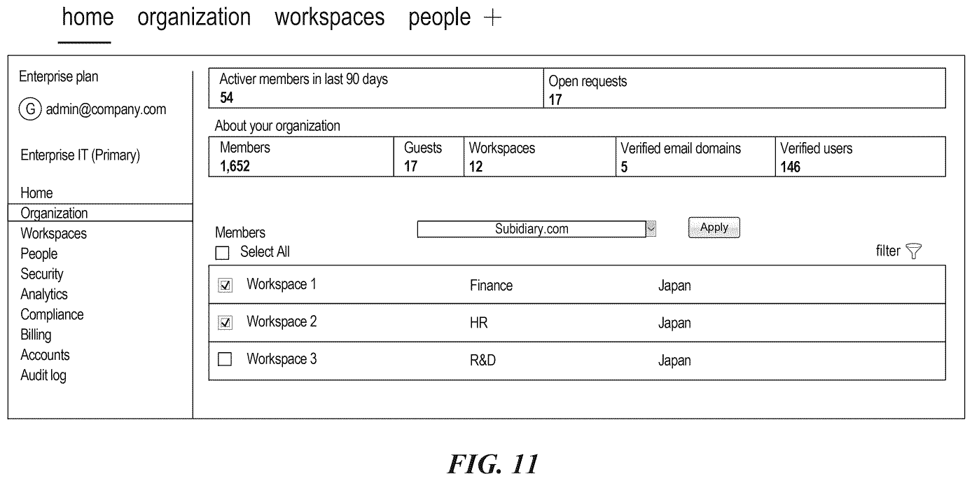

FIG. 11 illustrates an example setting interface for an organization administrator to manage organization identifier information across multiple workspaces in accordance with one or more embodiments of the present technology. As discussed in connection with FIGS. 5A-5C above, organizational structures can change over time, and the information identifying each organization adapts accordingly. Using the domain name as an example, as shown in FIG. 11, the workspaces can be filtered based on selected attributes (e.g., geographical locations and/or business functionality). A different domain name can be applied to the selected workspaces such that the selected workspaces can be updated to associate with a different organization. In some embodiments, the organization identifier is managed using a System for Cross-domain Identity Management (SCIM). The organization administrator can create SCIM groups to manage associations between the organization(s) and the workspace(s) (potentially also the teamspace(s) and members) dynamically.

In some embodiments, whether a setting should be propagated across members, workspaces, and/or teamspaces is based on one or more rules. In some embodiments, the rules can specify whether the setting is applicable or should be propagated to the workspaces/teamspaces based on a user type of the user who made the change of the setting. In some embodiments, the rules are related to whether the workspace is centrally managed as part of an organization (e.g., is already associated with the organization). Table 8 shows an example set of rules based on user types and workspace status.

TABLE 8
An example set of rules based on user types and workspace status

| | Workspaces | Workspaces belong to an |
|---|---|---|
| | don't belong | organization, being |
| | to an | centralized by an organization |
| | organization | administrator |
| Workspace | Cannot edit settings/settings | Cannot edit settings/settings |
| member | not visible | not visible |
| Workspace | Can edit settings/settings | Cannot edit settings/settings |
| owner | propagated to teamspaces | not propagated to teamspaces |
| Organization | Can edit settings/settings | Can edit settings/settings |
| administrator | propagated to workspaces | propagated to workspaces |
| | and teamspaces | and teamspaces |

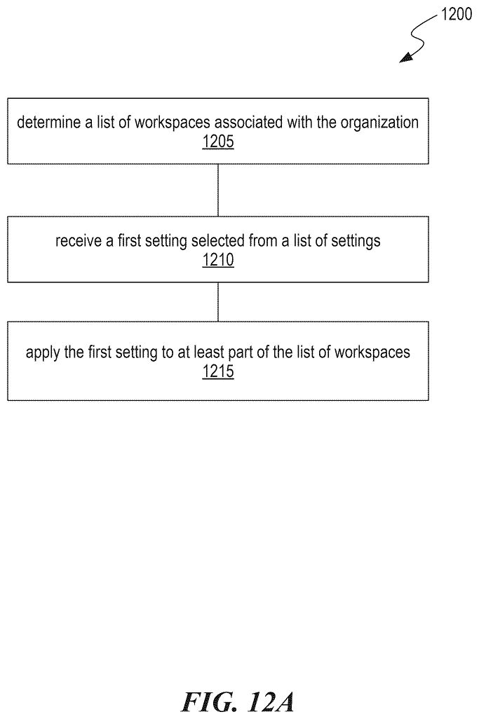

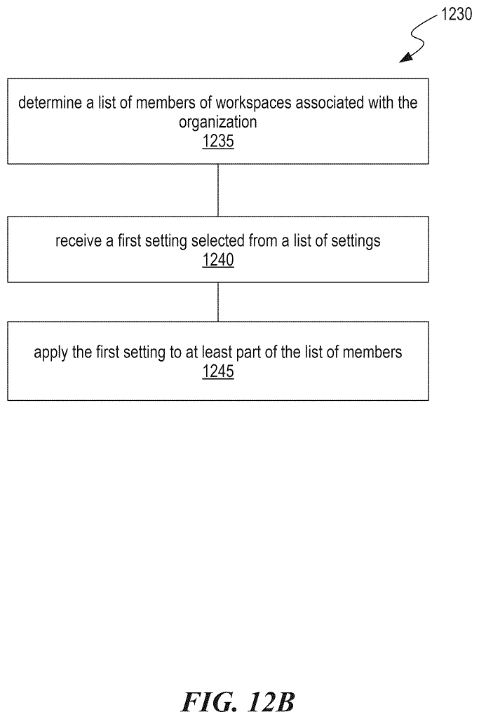

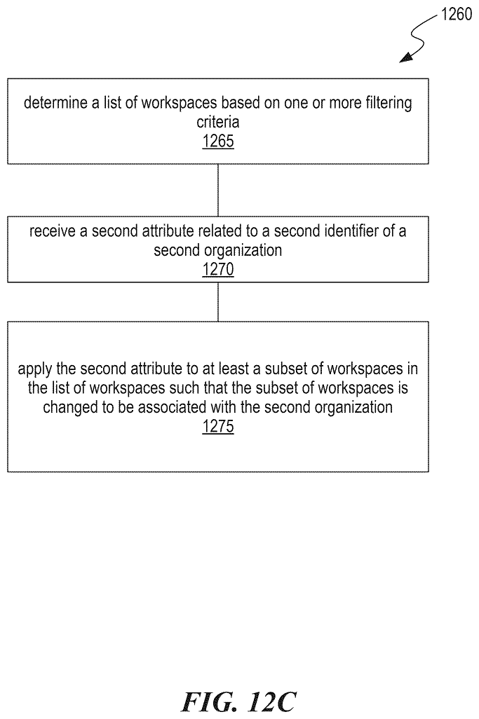

FIG. 12A is a flowchart representation of a computer-implemented method for managing enterprise-level information for an organization in accordance with one or more embodiments of the present technology. The method 1200 includes, at operation 1205, determining a list of workspaces associated with the organization based on an attribute that is common to the list of workspaces. The method 1200 includes, at operation 1210, receiving a first setting selected from a list of settings by a user. The method 1200 includes, at operation 1215, applying the first setting to at least part of the list of workspaces. The first setting is modifiable only by an organization administrator of the organization when the list of workspaces includes all workspaces associated with the organization, and the first setting is modifiable by the organization administrator and at least one workspace owner of a workspace when the list of workspaces includes part of all workspaces associated with the organization.

In some embodiments, the method includes determining that there exists a conflict between the first setting and a second setting of a workspace in the list of workspaces. In some embodiments, the method includes deleting the second setting of the workspace without input from the organization administrator. In some embodiments, the method includes providing an interface to enable the organization administrator to resolve the conflict.

FIG. 12B is a flowchart representation of another computer-implemented method for managing enterprise-level information for an organization in accordance with one or more embodiments of the present technology. The method 1230 includes, at operation 1235, determining a list of members of workspaces associated with the organization. The workspaces are associated with the organization based on an attribute that is common to the workspaces. At least two members in the list of members belong to different workspaces. The method 1230 includes, at operation 1240, receiving a setting selected from a list of settings by an organization administrator. The method 1230 includes, at operation 1245, applying the setting to at least part of the list of members.

In some embodiments, the list of members is selected from members of the workspaces based on one or more filtering criteria. The one or more filtering criteria comprise at least a user type of the members of the workspaces.

FIG. 12C is a flowchart representation of another computer-implemented method for managing enterprise-level information for an organization in accordance with one or more embodiments of the present technology. The method 1260 includes, at operation 1265, determining a list of workspaces based on one or more filtering criteria. The list of workspaces is associated with a first organization based on a first attribute related to a first identifier of the first organization. The method 1260 includes, at operation 1270, receiving a second attribute related to a second identifier of a second organization. The method 1260 includes, at operation 1275, applying the second attribute to at least a subset of workspaces in the list of workspaces such that the subset of workspaces is changed to be associated with the second organization based on the second attribute.

In some embodiments, the first organization and the second organization have a parent-subsidiary relationship. In some embodiments, at least one workspace in the list of workspaces is associated with the first organization and is accessible in the second organization.

### Computer System

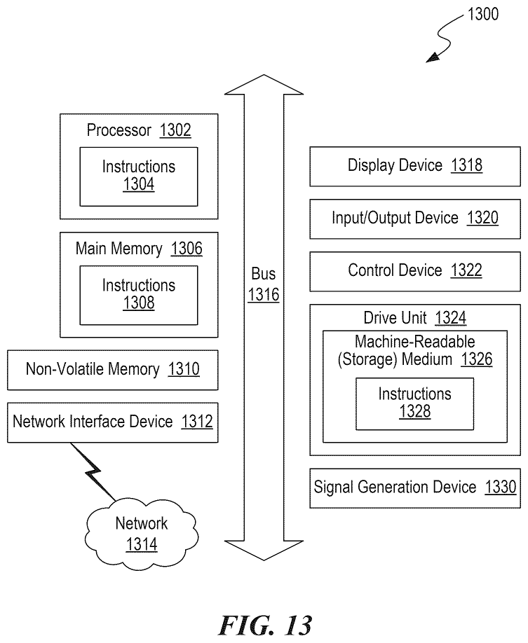

FIG. 13 is a block diagram that illustrates an example of a computer system 1300 in which at least some processes described herein can be implemented (e.g., methods described respectively with respect to FIG. 7, FIGS. 12A-12C). As shown, the computer system 1300 can include one or more processors 1302, main memory 1306, non-volatile memory 1310, a network interface device 1312, a display device 1318, an input/output device 1320, a control device 1322 (e.g., keyboard and pointing device), a drive unit 1324 that includes a machine-readable (storage) medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computer system 1300 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1300. In some implementations, the computer system 1300 can be an embedded computer system, a system-on-chip (SOC), a single-board computer (SBC) system, or a distributed system such as a mesh of computer systems or include one or more cloud components in one or more networks. Where appropriate, one or more computer systems 1300 can perform operations in real time, near real time, or batch mode.

The network interface device 1312 enables the computer system 1300 to mediate data in a network 1314 with an entity that is external to the computer system 1300 through any communication protocol supported by the computer system 1300 and the external entity. Examples of the network interface device 1312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1306, non-volatile memory 1310, machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable medium 1326 can include any medium that is capable of storing, encoding, or carrying a set of instructions for execution by the computer system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computer system 1300 to perform operations to execute elements involving the various aspects of the disclosure.

The computer system 1300 can be configured to access a remote language model server (e.g., a cloud-based language model) via the API 1328 or the network interface device 1312. For example, the computer system 1300 can communicate with a remote generative AI system to send instructions to and receive content from the generative AI system.

### Example Solutions

Example solutions related to the organization administration blocks are described below.

1. A computer-implemented solution for managing enterprise-level information for an organization, comprising: operating a first workspace associated with a first hierarchy of first multiple records arranged in multiple levels, wherein a record among the first multiple records includes content created by a first set of users; operating a second workspace associated with a second hierarchy of second multiple records arranged in multiple levels, wherein a record among the second multiple records includes content created by a second set of users, wherein the second set of users is at least partially different from the first set of users; determining, based on an attribute that is common to the first workspace and the second workspace, that the first workspace and the second workspace correspond to a same organization; associating an organization-level container with the first workspace and the second workspace based on the attribute to enable a setting configured in the organization-level container to be applied to the first workspace and the second workspace without impacting operations of the first workspace and the second workspace.

2. The computer-implemented method of solution 1, comprising, after the associating of the organization-level container with the first workspace and the second workspace: operating the second workspace independently from the first workspace.

3. The computer-implemented solution of solution 1, wherein the attribute comprises at least one of a domain name of the organization or a security configuration of the organization.

4. The computer-implemented method of solution 1, wherein the associating of the organization-level container with the first workspace and the second workspace comprises: using a joined table approach such that there exists and correspondence between a first table comprising the organization-level container and a second table comprising the first workspace and the second workspace.

5. The computer-implemented method of solution 1, comprising: applying the setting configured in the organization-level container to all workspaces associated with the organization-level container, wherein the setting configured in the organization-level container is modifiable only by an organization administrator of the organization.

6. The computer-implemented method of solution 1, comprising: applying the setting configured in the organization-level container to a subset of workspaces associated with the organization-level container, wherein the setting configured in the organization-level container is modifiable by a workspace owner of one of the subset of workspaces.

7. The computer-implemented method of solution 1, wherein the setting configured in the organization-level container is applied to the first workspace and the second workspace according to a rule that is based on at least one of (1) a user type, or (2) a status of the first workspace or the second workspace.

8. A non-transitory, computer-readable storage medium comprising instructions recorded thereon, wherein the instructions, when executed by at least one data processor of a system, cause the system to: operate a first workspace associated with a first hierarchy of first multiple records arranged in multiple levels, wherein a record among the first multiple records includes content created by a first set of users; operate a second workspace associated with a second hierarchy of second multiple records arranged in multiple levels independently from the first workspace, wherein a record among the second multiple records includes content created by a second set of users, wherein the second set of users is at least partially different from the first set of users; determine, based on an attribute that is common to the first workspace and the second workspace, that the first workspace and the second workspace correspond to a same organization; associate an organization-level container with the first workspace and the second workspace based on the attribute such that a setting configured in the organization-level container is applied to the first workspace and the second workspace without impacting independent operations of the first workspace and the second workspace.

9. The non-transitory, computer-readable storage medium of solution 8, wherein the instructions cause the system to: operate the second workspace independently from the first workspace after the associating of the organization-level container with the first workspace and the second workspace.

10. The non-transitory, computer-readable storage medium of solution 8, wherein the attribute comprises at least one of a domain name of the organization or a security configuration of the organization.

11. The non-transitory, computer-readable storage medium of solution 8, wherein the instructions cause the system to associate the organization-level container with the first workspace and the second workspace by using a joined table approach such that there exists and correspondence between a first table comprising the organization-level container and a second table comprising the first workspace and the second workspace.

12. The non-transitory, computer-readable storage medium of solution 8, wherein the instructions cause the system to: apply the setting configured in the organization-level container to all workspaces associated with the organization-level container, wherein the setting configured in the organization-level container is modifiable only by an organization administrator.

13. The non-transitory, computer-readable storage medium of solution 8, wherein the instructions cause the system to: apply the setting configured in the organization-level container to a subset of workspaces associated with the organization-level container, wherein the setting configured in the organization-level container is modifiable a workspace owner of one of the subset of workspaces.

14. The non-transitory, computer-readable storage medium of solution 8, wherein the setting configured in the organization-level container is applied to the first workspace and the second workspace according to a rule that is based on at least one of (1) a user type, or (2) a status of the first workspace or the second workspace.

15. An enterprise system, comprising: a first workspace, wherein one or more first records in the first workspace comprises content created by a first set of users; a second workspace, wherein one or more second records in the second workspace comprises content created by a second set of users, wherein the second set of users is at least partially different from the first set of users; a first organization-level space associated with the first workspace and the second workspace, wherein the first workspace and the second workspace are associated with the first organization-level space based on an attribute that is common to the first workspace and the second workspace, wherein a setting configured in the first organization-level space is applied to the first workspace and the second workspace without impacting independent operations of the first workspace and the second workspace.

16. The enterprise system of solution 15, wherein the attribute comprises at least one of: a domain name, or a security configuration.

17. The enterprise system of solution 15, further comprising: a third workspace, wherein one or more first records in the third workspace comprises content created by a third set of users, wherein the third set of users is at least partially different from the first set of users or the second set of users; a second organization-level space associated with the third workspace.

18. The enterprise system of solution 17, wherein one of the first workspace or the second workspace is associated with the first organization-level space and is accessible in the second organization-level space.

19. The enterprise system of solution 15, wherein a setting configured in the first organization-level space applicable to all workspaces associated with the first organization-level space is modifiable only by an organization administrator.

20. The enterprise system of solution 15, wherein a setting configured in the first organization-level space applicable to a subset of workspaces associated with the first organization-level space is modifiable by a workspace owner of one of the subset of workspaces.

Example solutions related to the tool provided to the organization administrator are described below.

21. A computer-implemented method for managing enterprise-level information for an organization, comprising: determining a list of workspaces associated with the organization based on an attribute that is common to the list of workspaces; receiving a first setting selected from a list of settings by a user; and applying the first setting to at least part of the list of workspaces, wherein the first setting is modifiable only by an organization administrator of the organization upon the list of workspaces comprising all workspaces associated with the organization, and wherein the first setting is modifiable by the organization administrator and at least one workspace owner of a workspace upon the list of workspaces comprising part of all workspaces associated with the organization.

22. The computer-implemented method of solution 21, comprising: determining that there exists a conflict between the first setting and a second setting of a workspace in the list of workspaces.

23. The computer-implemented method of solution 22, comprising: deleting the second setting of the workspace without input from the organization administrator.

24. The computer-implemented method of solution 22, comprising: providing an interface to enable the organization administrator to resolve the conflict.

25. The computer-implemented method of solution 21, wherein a workspace in the list of workspaces is associated with a hierarchy of multiple records arranged in multiple levels, and a record among the multiple records includes content created by one of members of the workspace.

26. The computer-implemented method of solution 21, wherein the attribute comprises at least one of a domain name of the organization or a security configuration of the organization.

27. The computer-implemented method of solution 21, wherein the first setting is applied to the at least part of the list of workspaces is according to a rule that is based on at least one of (1) a user type of the user, or (2) a status of a workspace in the list of workspaces.

28. A non-transitory, computer-readable storage medium comprising instructions recorded thereon, wherein the instructions, when executed by at least one data processor of a system, cause the system to implement the computer-implemented method of solution 21.

29. A computer-implemented method for managing enterprise-level information for an organization, comprising: determining a list of members of workspaces associated with the organization, wherein the workspaces are associated with the organization based on an attribute that is common to the workspaces, and wherein at least two members in the list of members belong to different workspaces; receiving a setting selected from a list of settings by an organization administrator; and applying the setting to at least part of the list of members.

30. The computer-implemented method of solution 29, wherein a workspace is associated with a hierarchy of multiple records arranged in multiple levels, and a record among the multiple records includes content created by one of members of the workspace.

31. The computer-implemented method of solution 29, wherein the attribute comprises at least one of a domain name of the organization or a security configuration of the organization.

32. The computer-implemented method of solution 29, wherein the list of members is selected from members of the workspaces based on one or more filtering criteria.

33. The computer-implemented method of solution 32, wherein the one or more filtering criteria comprise at least a user type of the members of the workspaces.

34. A non-transitory, computer-readable storage medium comprising instructions recorded thereon, wherein the instructions, when executed by at least one data processor of a system, cause the system to implement the computer-implemented method of solution 29.

35. A computer-implemented method for managing enterprise-level information, comprising: determining a list of workspaces based on one or more filtering criteria, wherein the list of workspaces is associated with a first organization based on a first attribute related to a first identifier of the first organization; receiving a second attribute related to a second identifier of a second organization; and applying the second attribute to at least a subset of workspaces in the list of workspaces such that the subset of workspaces is changed to be associated with the second organization based on the second attribute.

36. The computer-implemented method of solution 35, wherein a workspace in the list of workspaces is associated with a hierarchy of multiple records arranged in multiple levels, and a record among the multiple records includes content created by one of members of the workspace.

37. The computer-implemented method of solution 35, wherein the first attribute or the second attribute comprises at least one of a domain name or a security configuration of the first organization or the second organization.

38. The computer-implemented method of solution 35, wherein the first organization and the second organization have a parent-subsidiary relationship.

39. The computer-implemented method of solution 35, wherein at least one workspace in the list of workspaces is associated with the first organization and is accessible in the second organization.

40. A non-transitory, computer-readable storage medium comprising instructions recorded thereon, wherein the instructions, when executed by at least one data processor of a system, cause the system to implement the computer-implemented method of solution 35.

### REMARKS

The terms “example,” “embodiment,” and “implementation” are used interchangeably. For example, references to “one example” or “an example” in the disclosure can be, but are not necessarily, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A computer-implemented method for managing enterprise-level information for an organization, comprising:
determining a list of workspaces associated with the organization based on an attribute that is common to the list of workspaces;
receiving a first setting selected from a list of settings by a user; and
applying the first setting to at least part of the list of workspaces,
wherein the first setting is modifiable only by an organization administrator of the organization upon the list of workspaces comprising all workspaces associated with the organization, and
wherein the first setting is modifiable by the organization administrator and at least one workspace owner of a workspace upon the list of workspaces comprising part of all workspaces associated with the organization.

2. The computer-implemented method of claim 1, comprising:
determining that there exists a conflict between the first setting and a second setting of a workspace in the list of workspaces.

3. The computer-implemented method of claim 2, comprising:
deleting the second setting of the workspace without input from the organization administrator.

4. The computer-implemented method of claim 2, comprising:
providing an interface to enable the organization administrator to resolve the conflict.

5. The computer-implemented method of claim 1, wherein a workspace in the list of workspaces is associated with a hierarchy of multiple records arranged in multiple levels, and a record among the multiple records includes content created by one of members of the workspace.

6. The computer-implemented method of claim 1, wherein the attribute comprises at least one of a domain name of the organization or a security configuration of the organization.

7. The computer-implemented method of claim 1, wherein the first setting is applied to the at least part of the list of workspaces is according to a rule that is based on at least one of (1) a user type of the user, or (2) a status of a workspace in the list of workspaces.

8. A non-transitory, computer-readable storage medium comprising instructions recorded thereon, wherein the instructions, when executed by at least one data processor of a system, cause the system to implement the computer-implemented method of claim 1.

9. A computer-implemented method for managing enterprise-level information for an organization, comprising:
determining a list of members of workspaces associated with the organization,
wherein the workspaces are associated with the organization based on an attribute that is common to the workspaces, and
wherein at least two members in the list of members belong to different workspaces;
receiving a setting selected from a list of settings by an organization administrator; and
applying the setting to at least part of the list of members.

10. The computer-implemented method of claim 9, wherein a workspace is associated with a hierarchy of multiple records arranged in multiple levels, and a record among the multiple records includes content created by one of members of the workspace.

11. The computer-implemented method of claim 9, wherein the attribute comprises at least one of a domain name of the organization or a security configuration of the organization.

12. The computer-implemented method of claim 9, wherein the list of members is selected from members of the workspaces based on one or more filtering criteria.

13. The computer-implemented method of claim 12, wherein the one or more filtering criteria comprise at least a user type of the members of the workspaces.

14. A non-transitory, computer-readable storage medium comprising instructions recorded thereon, wherein the instructions, when executed by at least one data processor of a system, cause the system to implement the computer-implemented method of claim 9.

15. A computer-implemented method for managing enterprise-level information, comprising:
determining a list of workspaces based on one or more filtering criteria,
wherein the list of workspaces is associated with a first organization based on a first attribute related to a first identifier of the first organization;
receiving a second attribute related to a second identifier of a second organization; and
applying the second attribute to at least a subset of workspaces in the list of workspaces such that the subset of workspaces is changed to be associated with the second organization based on the second attribute.

16. The computer-implemented method of claim 15, wherein a workspace in the list of workspaces is associated with a hierarchy of multiple records arranged in multiple levels, and a record among the multiple records includes content created by one of members of the workspace.

17. The computer-implemented method of claim 15, wherein the first attribute or the second attribute comprises at least one of a domain name or a security configuration of the first organization or the second organization.

18. The computer-implemented method of claim 15, wherein the first organization and the second organization have a parent-subsidiary relationship.

19. The computer-implemented method of claim 15, wherein at least one workspace in the list of workspaces is associated with the first organization and is accessible in the second organization.

20. A non-transitory, computer-readable storage medium comprising instructions recorded thereon, wherein the instructions, when executed by at least one data processor of a system, cause the system to implement the computer-implemented method of claim 15.
